(19) United States
(12) Patent Application Publication
(10) Pub. No.: US 2004/0251069 A1
(43) Pub. Date: Dec. 16, 2004

(54) 4 x 4 Conversion kit

(76) Inventor: Scott Austin, Painted Post, NY (US)

Correspondence Address: Frank A. LaViola, Jr., Cameron Fabricating Corporation, P.O. Box 478, Horseheads, NY, 14845, US

(21) Appl. No.: 10/861,716

(22) Filed: Jun. 4, 2004

Related U.S. Application Data
(60) Provisional application No. 60/476,563, filed on Jun. 7, 2003.

(51) Int. Cl. B62D 6/00

(52) U.S. Cl. 180/233

(57) ABSTRACT

The present invention is a conversion kit to turn a new or used golf car from a conventional, two-wheel drive to a four-wheel drive vehicle. The four-wheel drive system can be engaged while static or while moving at any speed, forward or reverse. The kit has, in its simplest form, a CVT driven sheave adapter, a sprocket, and chain connecting to another sprocket. This combination drives a gear box which, in turn, rotates a drive shaft that connects to a differential. The differential transmits power to the previously non-driven set of wheels and thus turns the vehicle to four-wheel drive. The drive shaft may be made of a single shaft or may be multiple shafts coupled together depending upon the make and model of the golf car. The key advantages of this conversion kit are that it uses the existing drive train to accomplish its goal and is very cost effective and durable. The used golf car market can benefit from this conversion kit in that a four-wheel drive golf car has many more potential customers than a conventional two wheel drive golf car. The conversion kit can also be factory installed by manufacturers of golf cars and utility vehicles. Preventing damage to the turf and the safety of the riders are also key advantages of the conversion kit.

### RELATED APPLICATIONS

This application is related to provisional application 60/476,563 filed Jun. 7, 2003.

### BACKGROUND OF THE INVENTION

1. Field of the Invention

The present invention relates to a conversion kit for modifying a two wheel drive golf car or utility vehicle to be a four-wheel drive vehicle.

2. Description of Related Art

Currently, a four-wheel drive system for golf cars is available to the public. This system is hydraulic and includes many complex and expensive elements such as additional electric motors, hydraulic motors, pumps, front and rear lift kits, front bumper and many other items. This system is far more costly than the present invention and requires two different power systems. The known system is a self-contained unit that sits on the front of the vehicle and is run by a separate battery system. The present invention is a conversion kit that is incorporated directly into the existing drive train. The present invention is more efficient, simpler to attach and assemble and requires only a few simple modifications to the existing drive train to operate. Another 4×4 system uses two motors, one on the front axle and one on the rear. This system is very costly to manufacture due to its many parts and complexity of design. The present invention uses the existing drive train elements, some of them slightly modified, and the addition of a small number of new parts to achieve a four-wheel drive conversion.

There is a strong need for a simple, cost effective and durable four wheel drive conversion kit for golf cars and the like. The conversion kit is made for new and used golf cars and utility vehicles. One of the advantages of the conversion kit is that it may be offered in kit form or as an option that can be installed at the manufacturer. The kit works on both gas and battery powered golf cars with just a simple modification and rearrangement of parts. The markets that this invention will service include the new golf car manufacturers as well as the retrofitting of used golf cars by the end user themselves. Other markets can be serviced as well, including but not limited to, all terrain vehicles and other utility vehicles.

### SUMMARY OF THE INVENTION

The present invention solves a number of problems that currently face golf courses around the world. The first problem solved by the four-wheel drive conversion kit of the present invention is one of need. Currently, no manufacturer of golf cars offers a four-wheel drive option. The present invention can be used with new or used golf cars and can be either offered as an option at the factory or can be easily installed by the end user. The conversion kit uses the existing drive train of a golf car and, through linkages and bracketry, uses the existing power source to drive the previously non-driven set of wheels. The kit is versatile enough to be used on any make or model golf car with the addition or substitution of elements to accommodate the various configurations of the models. Gas powered and electrically powered golf cars are both able to be modified to become four-wheel drive with only minor variations to the base kit model.

The second problem solved by the four-wheel drive conversion kit of the present invention is in regards to damage caused by golf cars on golf courses. Due to the increasing popularity of golf as a recreational sport, golfers are turning out in record numbers to play at public, private and semi-private golf courses. This increased traffic on the courses has led to more rounds of golf being played per year and proportionally increased the amount of golf car activity at the courses. Since golf is played in all climates and weather conditions, the course conditions are sometimes less than pristine. Wet, muddy conditions do not deter the dedicated golfer or golf car use. Conventional two wheel drive golf cars are ill equipped to handle such wet and muddy conditions. Poor traction and slippage on wet turf are a main cause of damage to courses. A four-wheel drive golf car would virtually eliminate damage to golf courses caused by slippage and wheels spinning due to poor traction. Safety of the golfer is also an issue the present invention addresses. Steep, hilly courses, even in dry conditions, can benefit from the added traction and control afforded by four-wheel drive. Golfers, both experienced and novice, have encountered a time on the course where they must negotiate a steep hill or bank in muddy or slick conditions. This can be dangerous to the golfer and if not properly handled, can cause significant damage to the course. A four-wheel golf car would provide the golfers and golf course staff a much more “turf friendly” alternative to the conventional two-wheel drive golf car.

Another problem the conversion kit solves is that of economics and marketing. Since the conversion kit of the present invention can be applied to used golf cars, the used golf car market can be expanded into farm use, small business use, hunting and even homeowners. A used golf car, once equipped with the four-wheel drive conversion kit, is much more marketable to other industries outside of golf courses. Conventional two wheel drive golf cars are not rugged enough to handle the muddy conditions commonly found on farms and during the early winter months. The number of used golf cars is growing faster than the demand for the used cars. Used golf cars are hard to sell. The reason for this is that they have relatively no use to anyone other than golf courses or the occasional homeowner. With the conversion kit of the present invention, it is clear that the market for use has grown significantly.

Golf course owners and operators would also benefit from the conversion kit. They could take used golf cars, add the conversion kit to make them four-wheel drive, and turn them into maintenance vehicles or course ranger cars. They can also modify them to be driving range cars and provide them to workers on the course. This is a very inexpensive alternative to buying all-terrain vehicles or carts for the workers. They already own the golf car, they get virtually nothing for trade-in value and can do the modifications themselves.

The modification of conventional two wheel drive golf cars with the four wheel drive conversion kit would solve all the problems stated above with no known disadvantages. While the use of the present invention is primarily focused on golf cars, it should be made clear that the conversion kit of the present invention is not limited only to golf cars. While the following descriptions of use will cite golf cars specifically, ATV and utility vehicles would share the same benefits of the conversion kit of the present invention. In fact, the utility vehicle market can possibly become an even bigger market than the used golf car market. The popularity of golf is only exceeded by the popularity of off road vehicles such as ATVs and utility vehicles. The possibility of low cost and easy conversion of two-wheel drive to four-wheel drive vehicles is a very strong market to explore. The use of the conversion kit with both new and used vehicles make the markets for both very viable and potentially very profitable.

### BRIEF DESCRIPTION OF THE DRAWINGS

Embodiments of the present invention will now be described in detail in conjunction with the following drawings.

FIG. 1 shows a configuration of the parts of the conversion kit of the present invention applied to an existing drive train of a conventional, gas driven golf car using adapters to provide the power from the rear to the front wheels.

FIG. 2 shows another arrangement of the parts of the conversion kit similar to FIG. 1 except the drive shaft is made up of two, interconnected shaft members. The kit utilizes an external shaft coming from the transaxle to provide power to the front wheels.

FIG. 3 shows an additional arrangement the parts of the conversion kit of the present invention similar to FIG. 1 except two shafts are interconnected and arranged in a straight-line orientation.

FIG. 4 shows an alternate arrangement of parts of the conversion kit and has three interconnected shaft members.

FIG. 5 shows an arrangement of parts similar to FIG. 4 without a CVT adapter and running directly off the CVT transaxle shaft.

FIG. 6 shows a configuration of the parts of the conversion kit of the present invention as applied to the existing drive train of a conventional, battery powered golf car.

FIG. 7 shows a configuration similar to FIG. 6 except the gear box is positioned directly off the electric motor.

### DETAILED DESCRIPTION OF THE INVENTION

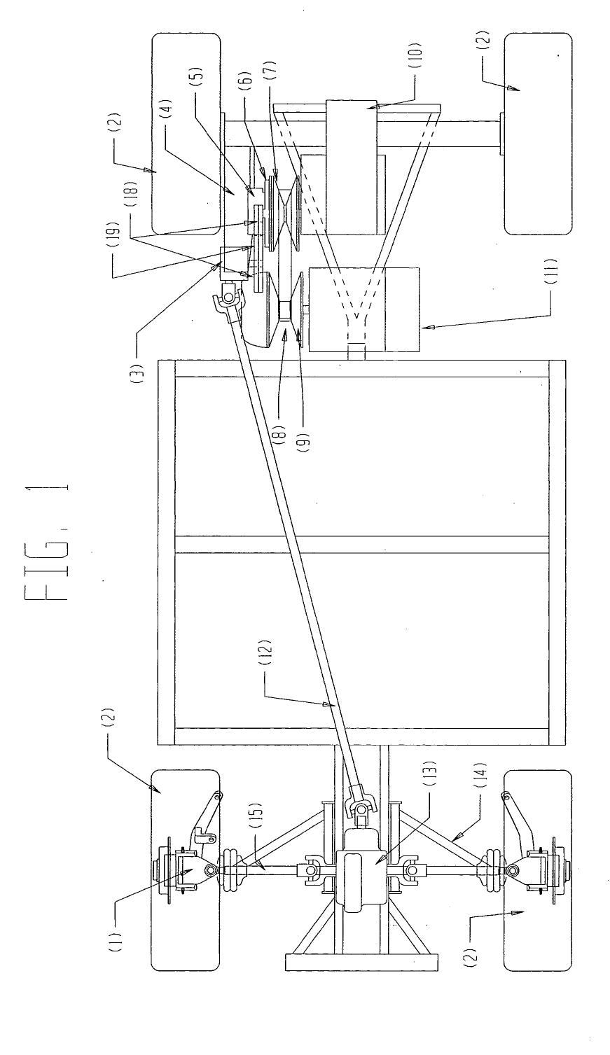

In the drawings, FIG. 1 shows the conversion kit of the present invention as it would be installed on a conventional, gas driven vehicle. Beginning at the drive end, gasoline engine 11 transmits power to CVT (Continuously Variable Transmission) drive clutch 9. CVT driven clutch 7 is modified to accept CVT adapter 6 and drive belt 8 interconnects the drive clutch 9 and driven clutch 7. An optional clutch 5 may be employed here to allow for the user to engage and disengage the drive system as needed. Sprockets 18 and chain 19 are used to drive gear box 3. The gear box 3 can be unidirectional or bi-directional. Sprockets 18 and chain 19 can be replaced by a sheave and belt arrangement. An optional clutch 5 can be added as shown to allow the user for engage and disengage the four-wheel drive capability at any time and as conditions warrant. The sprocket 18, chain 19, and gear box 3 set are held in place by mounting bracket 4. Gear box 3 then rotates drive shaft 12 which translates power from the rear of the golf car to the front end. The drive shaft 12 is coupled to a front differential 13 that distributes power to the left and right side via half shafts 15. The half shafts 15 are connected to the spindle/hub assembly 1 that rotate front tire and wheel assembly 2. Spindle/hub assembly 1 can alternately be a strut and hub assembly. Previously, front tire and wheel assembly 2 were not drive wheels. Through the modification of some existing elements and the addition of several new items, front tire and wheel assemblies are now powered without the need for a separate power source. All known conversions from two to four-wheel drive have employed a separate, complicated and expensive power source. The present invention uses the existing drive train to accomplish this objective. It should also be stated that optional suspension components such as control arms 14 may be added to make the ride smoother but are not essential to every conversion kit for operation. It should also be stated that the spindle/hub 1 can be of a strut/hub style and will not impact the functioning of the conversion kit.

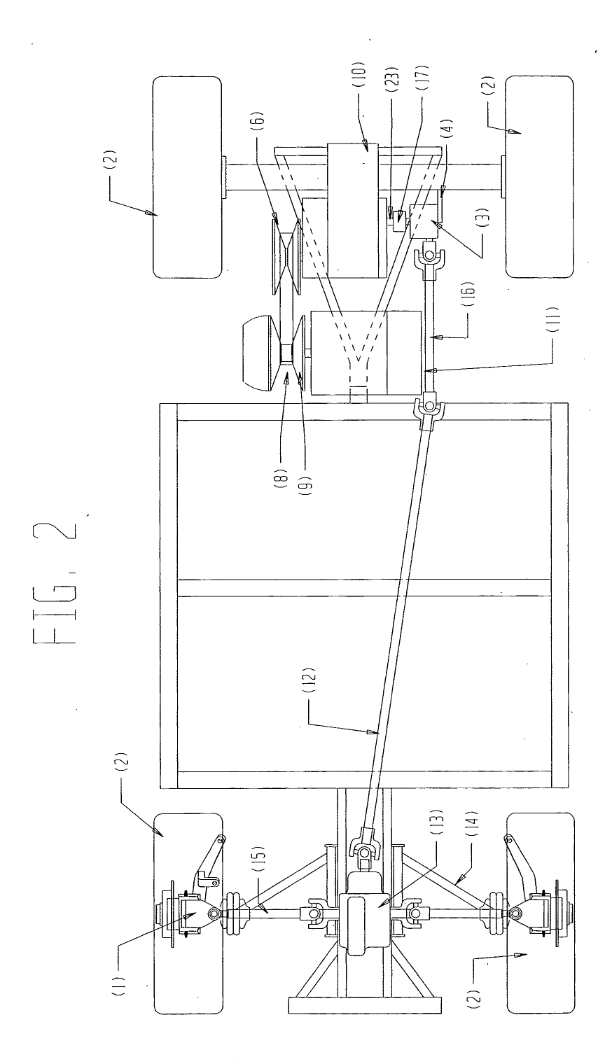

Turning now to FIG. 2, the basic arrangement is the same as FIG. 1 except for a few modifications. First, power is taken directly from transaxle 10 through transaxle output shaft 23 and connected to gear box 3 by way of external coupling 17. Gear box 3 may also be coupled directly to the output shaft 23. The elimination of coupling 17, sprocket 18 and chain 19 of FIG. 1 makes for a simpler design with less moving parts. Shown is a drive shaft that is made up of a first shaft 12 coupled to a second shaft 16. This will allow the user flexibility in the arrangement of parts where an application may not allow for a one piece shaft 12 as shown in FIG. 1. It should be stated that the drawing shows a two-piece drive shaft for illustrative purposes but a one piece shaft can be used as space and geometry allow.

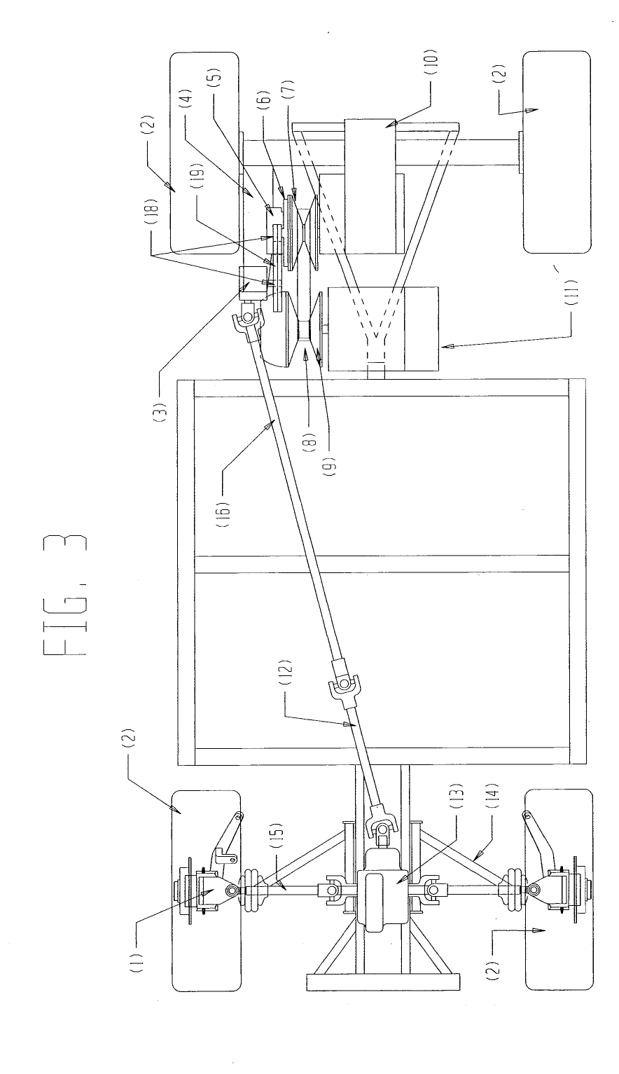

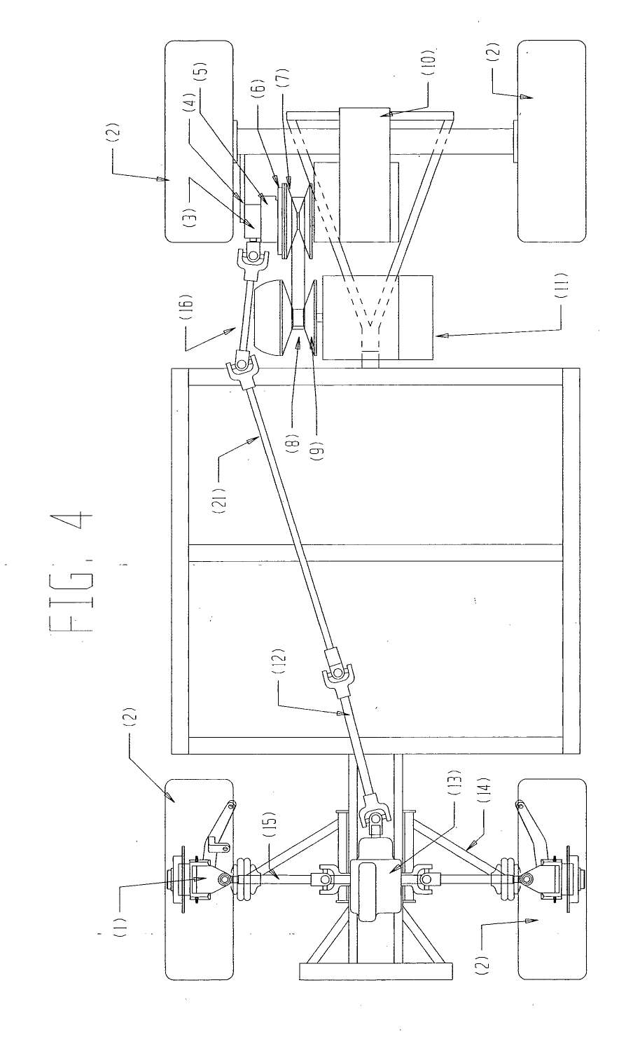

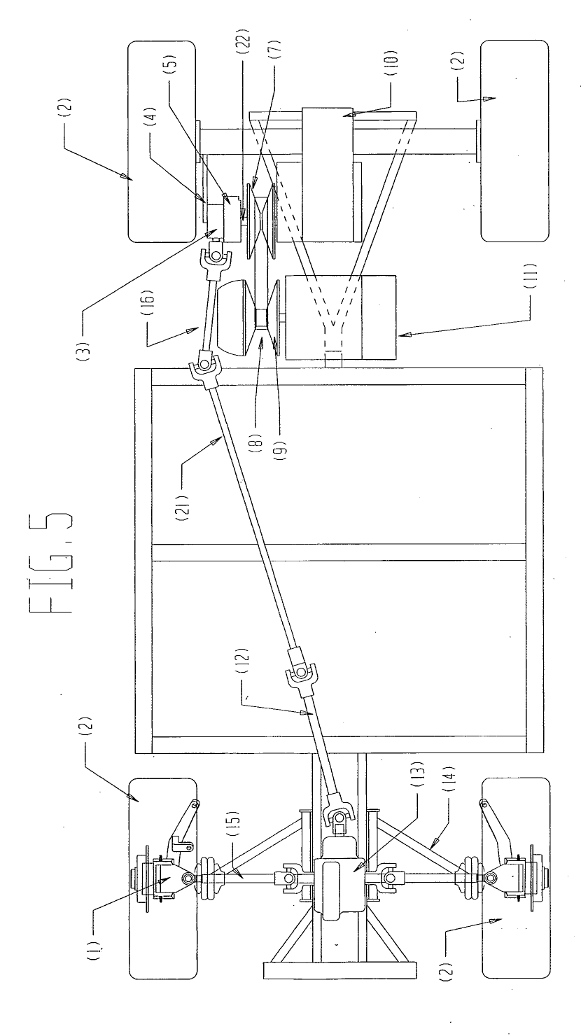

FIG. 3 shows an arrangement very similar to FIG. 1 except a two part drive shaft 12,16 is shown instead of a single drive shaft. Again, this is advantageous for the same reasons as stated above with regard to FIG. 2. Moving on to FIG. 4, the arrangement of elements is similar to FIG. 3 except the sprocket 18 and chain 19 arrangement is removed and replaced with a third shaft member 21. FIG. 5 shows the arrangement of FIG. 4 except that transaxle 10 and CVT transaxle output shaft 22 couple directly to gear box 3 without the need for adapter 6. If necessary, shaft 22 can be extended to eliminate adapter 6. Optional clutch 5, while still shown, may not be required.

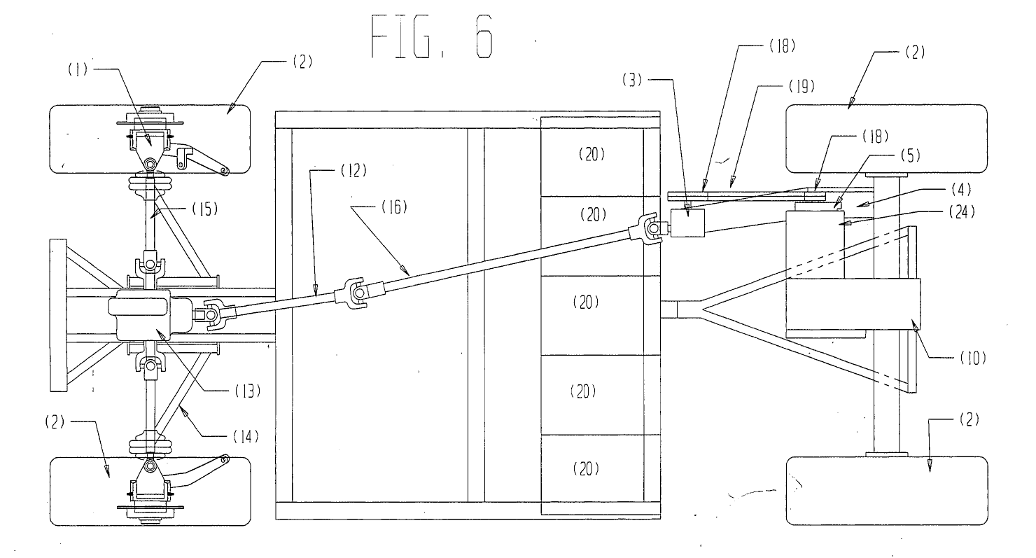

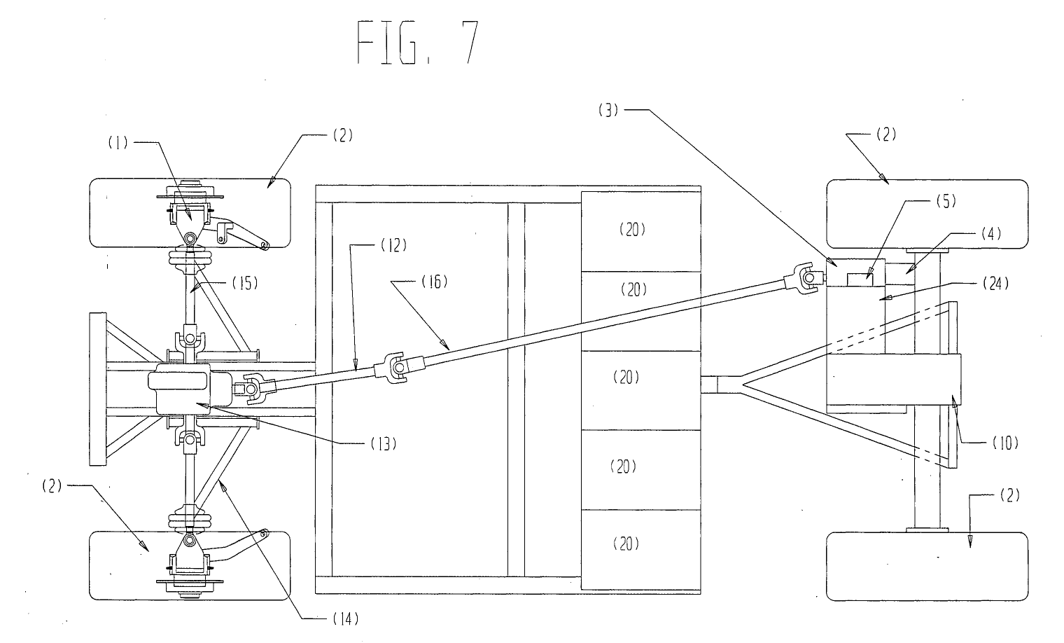

With regard to FIG. 6, the same basic configuration of parts is used as shown in FIG. 3 except they are applied to an electrically powered golf car. Gasoline engine 11 is replaced by electric motor 24. A bank of batteries 20 is shown which act as the power source for the electric motor 24. Power is transmitted directly from the motor 24 to the sprocket 18 and chain 19 assembly then to the gear box 3. Gear box 3 can also be directly attached to the electric motor 24 as shown in FIG. 7. The position of the gear box 3 can be on either end of the motor 24. The gear box 3 can be either between motor 24 and the transaxle 10 or directly on the outward end of the motor 24.

The optional clutch 5 can be added to any of the shown configurations to allow the user to engage and disengage the four-wheel drive option as required. The clutch 5 can be internal to the gear box or an externally mounted clutch. Also, any of the above configurations can be re-arranged and parts from one configuration can be substituted for parts from another configuration. Flexibility and choices are a key element of this inventive conversion kit and as long as a satisfactory result is achieved, interchanging parts from one system to another is well within the scope of this invention. Reversing the orientation of the parts shown as well as mirror imaging of parts is also within the scope of this invention to allow for varying output drive points. Changes in drive planes from horizontal to vertical are also possible within the scope of the present invention. All

1. A four-wheel drive conversion kit for use with a conventional two-wheel drive vehicle, the vehicle having: an engine, two driven tire and wheel assemblies, two undriven tire and wheel assemblies, a driven clutch, a drive belt, a drive clutch and a transaxle;
the conversion kit comprising: at least one drive shaft for providing power to the two undriven tire and wheel assemblies;
a front differential positioned between the two undriven tire and wheel assemblies; said at least one drive shaft being connected to said front differential at one end and connected to a gear box at its other end;
said gear box being connected to the engine of a vehicle;
two half shafts, each half shaft having a first a rid second end, said first end of each half shaft being connected to a separate spindle and hub assembly; each of said spindle and hub assembly being attached to said undriven tire and wheel assemblies;
said second end of each half shaft being connected to said front differential, said front differential being located in between said two half shafts; whereby the gear box transfers power from the engine through said at least one drive shaft and said front differential causing the two undriven tire and wheel assemblies to be driven and converting a two-wheel drive vehicle into a four-wheel drive vehicle.

2. A four-wheel drive conversion kit according to claim 1, said kit further comprising at least two control arms.

3. A four-wheel drive conversion kit according to claim 1, wherein said gear box is mounted independently and a sprocket and chain assembly is connected to said gear box; said gearbox, sprocket and chain assembly being supported by a mounting bracket.

4. A four-wheel drive conversion kit according to claim 3, said kit further comprises a CVT adapter.

5. A four-wheel drive conversion kit according to claim 1, said kit further comprises a clutch.

6. A four-wheel drive conversion kit according to claim 1, wherein a second drive shaft is coupled to said first drive shaft to allow for greater flexibility in configuring the system when installed.

7. A four-wheel drive conversion kit according to claim 6, wherein a third drive shaft is coupled to said first and second drive shafts to allow for greater flexibility in configuring the system when installed.

8. A four-wheel drive conversion kit according to claim 1, said kit further comprising a transaxle output shaft which can replace or modify an existing transaxle shaft.

9. A four-wheel drive conversion kit according to claim 8, said kit further comprising a coupling for attachment to said transaxle output shaft.

10. A four-wheel drive conversion kit according to claim 1, said kit further comprising a CVT transaxle shaft which can replace or extend an existing CVT transaxle shaft.

11. A four-wheel drive conversion kit according to claim 10, wherein said gear box is mounted directly to CVT transaxle shaft.

12. A four-wheel drive conversion kit according to claim 4, wherein the CVT driven clutch is modified to accept said CVT adapter.

13. A four-wheel drive conversion kit according to claim 4, wherein said gearbox is mounted to said CVT adapter.

14. A four-wheel drive conversion kit according to claim 8, wherein said gearbox is mounted directly to said transaxle output shaft.

15. A four-wheel drive conversion kit according to claim 1, wherein said gear box has an internal clutch.

16. A four-wheel drive conversion kit for use with a conventional two-wheel drive vehicle, the vehicle having: an electric motor, two driven tire and wheel assemblies, two undriven tire and wheel assemblies, at least one battery and a transaxle;
the conversion kit comprising: at least one drive shaft for providing power to the two undriven tire and wheel assemblies;
a front differential positioned between the two undriven tire and wheel assemblies; said at least one drive shaft being connected to said front differential at one end and connected to a gear box at its other end;
said gear box being connected to the electric motor of a vehicle;
two half shafts, each half shaft having a first and second end, said first end of each half shaft being connected to a separate spindle and hub assembly; each of said spindle and hub assembly being attached to said undriven tire and wheel assemblies;
said second end of each half shaft being connected to said front differential, said front differential being located in between said two half shafts; whereby the gear box transfers power from the electric motor through said at least one drive shaft and said front differential causing the two undriven tire and wheel assemblies to be driven and converting a two-wheel drive vehicle into a four-wheel drive vehicle.

17. A four-wheel drive conversion kit according to claim 16, said kit further comprising at least two control arms.

18. A four-wheel drive conversion kit according to claim 16, wherein said gear box is mounted independently and a sprocket and chain assembly connected to said gear box; said gearbox, sprocket and chain assembly being supported by a mounting bracket.

19. A four-wheel drive conversion kit according to claim 16, wherein said gear box is mounted externally to said electric motor.

20. A four-wheel drive conversion kit according to claim 16, wherein said gear box is mounted between said electric motor and said transaxle.

21. A four-wheel drive conversion kit according to claim 16, said kit further comprises a clutch.

22. A four-wheel drive conversion kit according to claim 16, wherein said gear box has an internal clutch.
